(19) United States
(12) Patent Application Publication
(10) Pub. No.: US 2009/0158093 A1
(43) Pub. Date: Jun. 18, 2009

(54) MOTHERBOARD TESTER

(75) Inventors: RAN CHEN, Shenzhen (CN); DA-YOU CHEN, Shenzhen (CN); GUANG-DONG YUAN, Shenzhen (CN); CHUNG-CHI HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/963,877

(22) Filed: Dec. 24, 2007

(30) Foreign Application Priority Data
Dec. 13, 2007 (CN) 200710203028.5

(51) Int. Cl. G06F 11/273

(52) U.S. Cl. 714/32; 714/E11.17

(57) ABSTRACT

An exemplary motherboard tester includes a processor comprising a pair of data terminals for transmitting data; and an interface comprising: a pair of data terminals coupled to the data terminals of the processor respectively; at least one output terminal arranged for connecting to a corresponding pin of a chipset mounted on a motherboard to send a test signal generated by the processor to the pin; and at least one input terminal arranged for connecting to a test point on the motherboard which is electrically connected to the pin, to receive a feedback signal from the test point, wherein, the processor compares the feedback signal with the test signal to determine whether the pin of the chipset is normal, open, or shorted.

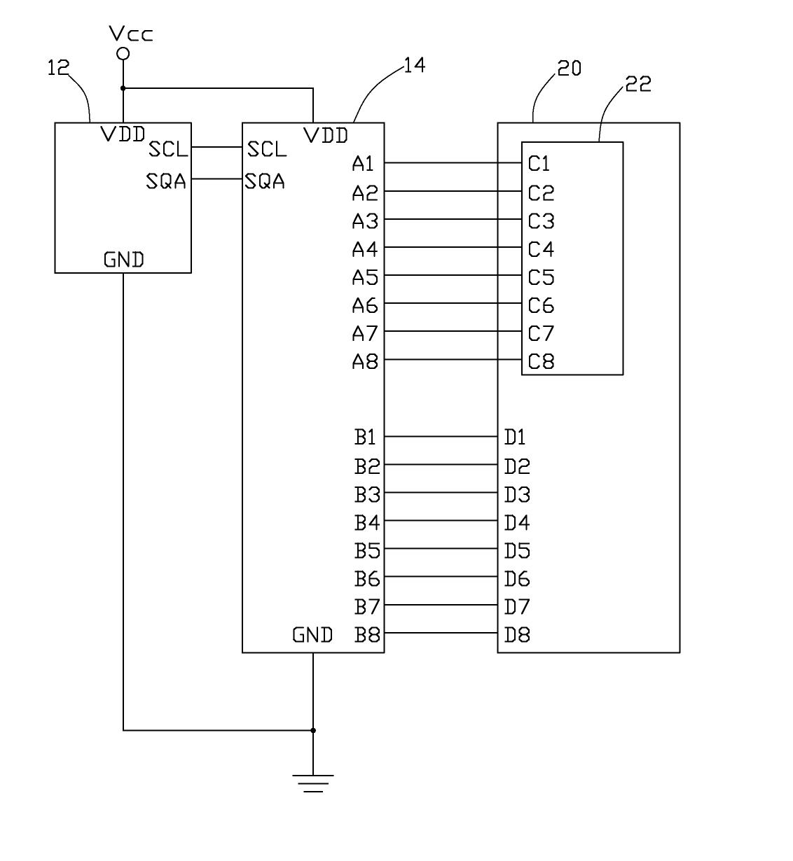

### BACKGROUND

1. Field of the Invention

The present invention relates to testers, and particularly to a motherboard tester.

2. Description of Related Art

In-circuit tests (ICT) are typically used to test a motherboard to ensure the proper functioning and operation thereof. If the motherboard successfully passes the test, it may be passed on for incorporation into the appropriate sub-assembly or into the final product. If, on the other hand, the motherboard fails the test, it may either be repaired or scrapped.

When operators need to test a part of the motherboard, such as a specific chipset. Such an ICT test apparatus, however, needs many components and indicators, and makes the method of testing complex.

What is needed, therefore, is a motherboard tester which can solve above problem.

### SUMMARY

An exemplary motherboard tester comprises a processor comprising a pair of data terminals for transmitting data; and an interface comprising: a pair of data terminals coupled to the data terminals of the processor respectively; at least one output terminal arranged for connecting to a corresponding pin of a chipset mounted on a motherboard to send a test signal generated by the processor to the pin; and at least one input terminal arranged for connecting to a test point on the motherboard which is electrically connected to the pin, to receive a feedback signal from the test point, wherein, the processor compares the feedback signal with the test signal to determine whether the pin of the chipset is normal, open, or shorted.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a circuit diagram of a motherboard tester in accordance with an embodiment of the present invention.

### DETAILED DESCRIPTION

Referring to the drawing, a motherboard tester in accordance with an embodiment of the present invention includes a processor 12 and an interface 14. The processor 12 includes a pair of data terminals SCL and SQA, a power terminal VDD, and a ground terminal GND. The interface 14 includes a pair of data terminals SCL and SQA, a power terminal VDD, a ground terminal GND, eight output terminals A1˜A8, and eight input terminals B1˜B8.

The power terminals VDD of the processor 12 and the interface 14 are connected to a power source Vcc, the ground terminals of the processor 12 and the interface 14 are grounded. The data terminals SCL and SQA of the processor 12 are connected to the data terminals SCL and SQA of the interface 14 respectively for transmitting data. The output terminals A1˜A8 of the interface 14 are connected to pins C1˜C8 of a chipset 22 mounted on a motherboard 20 respectively. The input terminals B1˜B8 are connected to test points D1˜D8 on the motherboard 20 respectively. The test points D1˜D8 are electrically connected to the pins C1˜C8 of the chipset 22 when the chipset 22 is soldered on the motherboard 20.

In this embodiment of the invention, the test points D1˜D8 are pads which are used to solder the pins C1˜C8 of the chipset 22 thereon respectively. In another embodiment of the invention, the test points D1˜D8 are nodes on transmission lines connected to the pads which are used to solder the pins C1˜C8 of the chipset 22 thereon respectively.

When operators need to test the connection of the chipset 22, the processor 12 generates a test signal such as an eight bit Transistor-Transistor Logic (TTL) signal to the interface 14. The interface 14 converts the serial TTL signal to eight parallel signals and sends the parallel signals to the pins C1˜C8 of the chipset 22. That is the pins C1, C3, C5, and C7 receive a high level voltage signal, and the pins C2, C4, C6, and C8 receive a low level voltage signal. The interface 14 receives feedback signals from the test points D1˜D8 and converts the eight parallel signals to a serial signal and sends the serial signal to the processor 12. The processor 12 compares the serial signal with the TTL signal to determine whether each of the pins C1˜C8 of the chipset 22 are normal, open, or shorted.

For example, if the interface 14 does not receive the feedback signal from the test point D1, the pin C1 of the chipset 22 is open; if the feedback signal received from the test point D1 is at a low level, the pin C1 of the chipset 22 is shorted; if the feedback signal received from the test point D1 is at a high level, the pin C1 of the chipset 22 is normal.

Therefore, operators can test a part of the motherboard 20 such as the chipset 22 with only the motherboard tester. The processor 12 is further connected to a display to indicate status of the connection of the pins C1˜C8 of the chipset 22.

In this embodiment of the invention, an amount of the output terminals of the interface 14 is eight, the amount of the input terminals of the interface 14 is eight, in other embodiments however, the amount of the input terminals and the output terminals of the interface 14 are not limited to eight.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A motherboard tester comprising:
a processor comprising a pair of data terminals for transmitting data; and
an interface comprising:
a pair of data terminals coupled to the data terminals of the processor respectively;
at least one output terminal arranged for connecting to a corresponding pin of a chipset mounted on a motherboard to send a test signal generated by the processor to the pin; and
at least one input terminal arranged for connecting to a test point on the motherboard which is electrically connected to the pin, to receive a feedback signal from the test point,
wherein, the processor compares the feedback signal with the test signal to determine whether the pin of the chipset is normal, open, or shorted.

2. The motherboard tester as claimed in claim 1, wherein if the test signal is at a high level and the feed back signal is at a low level, the pin of the chipset is shorted.

3. The motherboard tester as claimed in claim 1, wherein if the input terminal of the interface does not receive the feedback signal, the pin of the chipset is open.

4. The motherboard tester as claimed in claim 1, wherein the test point is a pad arranged for soldering the pin of the chipset or a node of a transmission line connected to the pad.
